(19) United States
(12) Patent Application Publication
(10) Pub. No.: US 2024/0258044 A1
(43) Pub. Date: Aug. 1, 2024

(54) PRESSURE VESSEL

(71) Applicant: Schneider Electric Industries SAS, Rueil-Malmaison (FR)

(72) Inventors: Alban Notin, Wörth an der Donau (DE); Tobias Humbs, Bernhardswald (DE); Arun Nair, Regensburg (DE); Satish Namala, Bangalore (IN)

(73) Assignee: Schneider Electric Industries SAS, Rueil-Malmaison (FR)

(21) Appl. No.: 18/423,701

(22) Filed: Jan. 26, 2024

(30) Foreign Application Priority Data
Jan. 31, 2023 (DE) 102023102362.4

(51) Int. Cl. H01H 9/04

(52) U.S. Cl. CPC H01H 9/04

(57) ABSTRACT

The invention relates to a gas-tight pressure vessel for a switch panel of electrical energy technology, in particular of medium-voltage technology, comprising at least one stiffening element fastened to an outer side of the pressure vessel.

The invention relates to a gas-tight pressure vessel for a switch panel of electrical energy technology, in particular of medium-voltage technology, comprising at least one stiffening element fastened to an outer side of the pressure vessel.

Electrical energy is usually distributed by means of switchgear. Switchgear typically comprise individual switch panels that are usually connected via common busbars. In this respect, the individual switch panels can comprise gas-tight pressure vessels in which components such as circuit breakers, busbar sections or current and voltage measurement units of the respective switch panel are arranged. A plurality of such switch panels are usually installed tightly next to one another in a row. For maintenance purposes, it may be necessary to pull the corresponding switch panel out of the row after release and to push it back into the gap produced after repair or replacement.

Up to now, pressure vessels have, for example, been filled with sulfur hexafluoride as an insulating gas to increase the dielectric strength of the switch panel. However, in addition to a high electrical strength, sulfur hexafluoride also has a high global warming potential, which is why alternative insulating gases are increasingly being used. However, they often have a lower electrical strength compared to sulfur hexafluoride so that such alternative insulating gases must be used at higher pressures compared to sulfur hexafluoride.

A pressure vessel can generally only withstand deformation to a limited degree due to the internal pressure, regardless of the respective insulating gas. If a deformation occurs, components arranged at a pressure vessel, such as leadthroughs, can be damaged. A buckling or bending of pressure vessels in the region of busbar leadthroughs is in particular to be prevented since they usually comprise a rigid plastic material that can be damaged in the event of a bending stress. To prevent a buckling, it is therefore common practice to reinforce pressure vessels with stiffening elements fastened thereto.

It is the underlying object of the invention to provide a pressure vessel having an increased mechanical strength, wherein the installation and the removal of the pressure vessel is simplified.

This object is satisfied by a pressure vessel having the features of claim 1.

The invention is in this respect based on the idea of stiffening outer sides of adjacent pressure vessels that are spaced apart in parallel in that the stiffening element is fastened to the outer side of a pressure vessel, on the one hand, and, on the other hand, when the stiffening element is telescoped out, can contact a contact surface of the outer side of an adjacent pressure vessel.

During installation, a switch panel comprising a pressure vessel according to the invention having a telescoped-in stiffening element can be inserted into a gap between two adjacent switch panels, i.e. next to an adjacent pressure vessel. This can in this respect take place particularly easily since the telescoped-in stiffening element is slightly spaced apart from the outer wall of the adjacent pressure vessel. The stiffening element can then be telescoped out and locked. In this state spread between the two outer sides, the stiffening element cannot be telescoped in due to the locking, whereby both adjacent pressure vessels are stiffened against one another. However, the telescoped-in stiffening element can also already contribute to a stiffening of the pressure vessel according to the invention.

The installation and the removal of the adjacent pressure vessel are simplified by the pressure vessel according to the invention: The stiffening element of the pressure vessel according to the invention is telescoped in for the installation and removal of the adjacent pressure vessel. Since, due to the stiffening element of the pressure vessel according to the invention, no separate stiffening element, for example in the form of struts, has to be provided at the contact surface of the adjacent pressure vessel to stiffen it, which separate stiffening element would otherwise project beyond the adjacent pressure vessel, the adjacent pressure vessel can be pushed in and pulled out particularly easily.

The same also applies in the case of adjacent pressure vessels according to the invention.

A further advantage is that the stiffening element is fastened outside the pressure vessel according to the invention. It would generally also be conceivable to provide a pressure vessel with stiffening elements in its interior. However, since the pressure vessel according to the invention is stiffened at the outside, there is more space available in its interior for the respective insulating gas, whereby the dielectric strength of a switch panel comprising the pressure vessel according to the invention is increased.

Advantageous embodiments of the invention result from the dependent claims, from the description, and from the Figures.

According to a first advantageous embodiment, the stiffening element can comprise at least one slot guide and at least one latch that is arranged in the slot guide. In this respect, the movement of the stiffening element during telescoping and locking is predefined by the course of the slot guide. The stiffening element is hereby configured as telescopic and lockable in a particularly simple manner and a compact and space-saving arrangement is achieved, whereby the installation and the removal of the pressure vessel are simplified.

According to a further advantageous embodiment, the slot guide can comprise a telescoping section, in which the latch is arranged during telescoping, and at least one locking section in which the latch is arranged during locking, with the latch and the locking section being releasably latchable to one another. The stiffening element can thereby be particularly easily locked depending on the position of the latch in the slot guide without, for example, having to insert separate locking elements into the stiffening element for this purpose. The locking is therefore achieved simply by the shaping of the slot guide. The latch advantageously latches to the locking section when the stiffening element is telescoped out. The stiffening element can then no longer be telescoped in and ensures a reliable stiffening.

According to a further advantageous embodiment, the slot guide can have a U-shaped recess, with two parallel sections of the recess forming a first locking section and a second locking section which are connected to one another via the telescoping section. In this way, the stiffening element can be particularly easily locked in two states, namely when it is telescoped out or telescoped in. In particular for transportation or maintenance purposes, it is advantageous to lock the stiffening element even when it is telescoped in so that this embodiment also simplifies the installation and removal of the pressure vessel. Furthermore, this design of the slot guide allows a particularly reliable stiffening since the wall of the slot guide in the locking sections is oriented perpendicular to a force introduction of the latch.

According to a further advantageous embodiment, the slot guide can be formed in a plane perpendicular to the outer side, with the latch being arranged in parallel with the outer side in the slot guide. Due to this orientation, a particularly uniform force introduction into the stiffening element and a reliable stiffening are achieved. Furthermore, the stiffening element is particularly compact and space-saving.

According to a further advantageous embodiment, the stiffening element can comprise a plurality of ribs and/or rib pairs spaced apart in parallel from one another. An inherently rigid and simultaneously compact structure of the stiffening element in a rib design is hereby achieved.

According to a further advantageous embodiment, each rib pair can comprise at least one fixed rib, which is oriented perpendicular to the outer side and fastened thereto, and at least one rib that is displaceable relative to the fixed rib and that in particular contacts the fixed rib. Alternatively, two displaceable ribs and one fixed rib per rib pair would, for example, also be conceivable, wherein the displaceable ribs could be arranged at both sides of the fixed rib. Due to the perpendicular orientation, a particularly uniform force introduction into the stiffening element and a reliable stiffening are achieved. Furthermore, the stiffening element is particularly compact and space-saving. Shear forces can in particular be reduced if the displaceable rib contacts the fixed rib.

According to a further advantageous embodiment, at least one rib of the stiffening element has a slot guide in which a latch is arranged. In this respect, the rib is in particular a rib of one of the above-described rib pairs. The slot guide can likewise be designed as one of the above-described slot guides.

According to a further advantageous embodiment, at least one rib of the stiffening element has an opening in which a latch is received in a form-fitting and/or force-fitting manner. The rib can in this respect be the rib of the previous embodiment—which would consequently have the slot guide and the opening—or another rib of one of the above-described rib pairs. Equally, the latch of this embodiment can be the latch of the previous embodiment or a different latch.

According to a further advantageous embodiment, at least one fixed rib of at least one rib pair can have a slot guide in which a latch is arranged, with at least one displaceable rib of the rib pair having an opening in which the latch is received in a form-fitting and/or force-fitting manner. The slot guide can in this respect be designed in accordance with the above-described slot guides. Via the latch and the slot guide, the displaceable rib is guided in a displaceable and space-saving manner relative to the fixed rib in accordance with the course of the slot guide. If the stiffening element is telescoped, the latch is displaced in the slot guide.

According to a further advantageous embodiment, at least one displaceable rib of at least one rib pair can have a slot guide in which a latch is arranged, with at least one fixed rib of the rib pair having an opening in which the latch is received in a form-fitting and/or force-fitting manner. The slot guide can in this respect be designed in accordance with the above-described slot guides. Via the slot guide and the latch, the displaceable rib is guided in a displaceable and space-saving manner relative to the fixed rib in accordance with the course of the slot guide. If the stiffening element is telescoped, the slot guide is displaced at the latch. In particular if the displaceable rib and the fixed rib of this embodiment are the respective displaceable and fixed ribs of the previous embodiment, the slot guide and the opening of the displaceable rib and the fixed rib can have the same design. In this case, both ribs can be identical components, whereby the manufacture of the stiffening element is simplified.

According to a further advantageous embodiment, the stiffening element can comprise a fixed profile part which has at least one bead, which is fastened to the outer side and to which the fixed ribs are fastened, with the outer contours of the fixed ribs being adapted to the cross-sectional shape of the fixed profile part. Via the fixed profile part, the stiffening element is fastened in a simple manner, in particular welded, to the outer side of the pressure vessel. Furthermore, the fixed profile part in this respect has an additional stiffening effect and a reliable and uniform force introduction into the stiffening element takes place.

According to a further advantageous embodiment, at least one passage can be formed between the fixed profile part and the outer side and/or between the fixed profile part and all the fixed ribs, said passage being provided to be able to guide a functional component of the switch panel through the passage of the stiffening element. Such a passage can, for example, be formed by the bead of the fixed profile part and/or a recess at all the fixed ribs.

According to a further advantageous embodiment, the stiffening element can comprise a displaceable profile part that has at least one bead and that is fastened, in particular welded, to the displaceable ribs, with the outer contours of the displaceable ribs being adapted to the cross-sectional shape of the displaceable profile part. Via the displaceable profile part, the stiffening element can be fastened in a simple manner, in particular screwed, to an outer side, spaced apart in parallel from the outer side, of a second pressure vessel arranged spaced apart in parallel by a spacing D. The installation and removal of the pressure vessel according to the invention and of the adjacent second pressure vessel are hereby considerably simplified since only the fastening of the displaceable profile part needs to be loosened after which the stiffening element can be telescoped. The displaceable profile part has a stiffening effect in addition to the rib arrangement and provides a reliable and uniform force introduction into the stiffening element. Alternatively, the displaceable ribs can, for example, come into direct contact with the adjacent outer side or an assembly plate fastened thereto.

According to a further advantageous embodiment, the latch can be designed as a rod or bolt that extends in an axial direction, wherein the ends of the latch can each be provided with a securing device, in particular a nut and/or a cotter pin, whereby the latch is secured against an axial movement. The rod is advantageously guided through all the ribs involved, whereby the stiffening element is particularly simple, compact and space-saving. Furthermore, a uniform force introduction into the stiffening element takes place based on the led-through rod. If, for example, only individual screw connections were provided to connect the ribs of the individual rib pairs, a less uniform force introduction would in contrast take place.

According to a further advantageous embodiment, the stiffening element can comprise at least three component sets having different components, with each of the three component sets including at least two identical components, in particular having identical shapes. In this respect, all the latches, all the ribs and all the profile parts of the stiffening element can each represent a component set, for example. In particular, all the latches and/or all the ribs and/or all the profile parts of the stiffening element can each have an identical shape. The number of different components of the stiffening element is thereby reduced, whereby the manufacture becomes simpler and more cost-effective.

According to a further advantageous embodiment, the pressure vessel can have a cable connection compartment, a busbar compartment and a circuit breaker compartment.

The invention further relates to an arrangement of a first switch panel comprising a first pressure vessel according to the invention and a second pressure vessel which is arranged adjacent thereto by a spacing D and at whose outer side, which is spaced apart in parallel from the outer side of the first pressure vessel and disposed opposite thereto, an assembly plate is fastened at which the stiffening element of the first pressure vessel is mounted.

Furthermore, the invention relates to a switch panel of electrical energy technology, in particular of medium-voltage technology, comprising a pressure vessel according to the invention.

Furthermore, the invention relates to an arrangement of a first switch panel comprising a pressure vessel according to the invention and a second switch panel that is arranged adjacent thereto by a spacing D and that has a second pressure vessel at whose outer side, which is spaced apart in parallel from the outer side of the pressure vessel of the first switch panel and disposed opposite thereto, an assembly plate is fastened at which the stiffening element of the first pressure vessel is mounted.

In a further development of the above arrangement of two adjacent pressure vessels comprising a pressure vessel according to the invention and a second pressure vessel, at least one separately formed blade contacting the outer sides of the pressure vessels can be provided that has an engagement projection that engages into the stiffening element, whereby the blade additionally blocks the stiffening element.

The invention furthermore relates to a method for stiffening a pressure vessel according to the invention that is arranged in a switch panel, wherein the switch panel is arranged spaced apart in parallel from an adjacent second switch panel having a second pressure vessel, comprising the following steps: transferring the stiffening element to the telescoped-out state, locking the stiffening element, and fastening the stiffening element to the second pressure vessel.

The invention will be described in the following by way of example with reference to the Figures. It schematically shows:

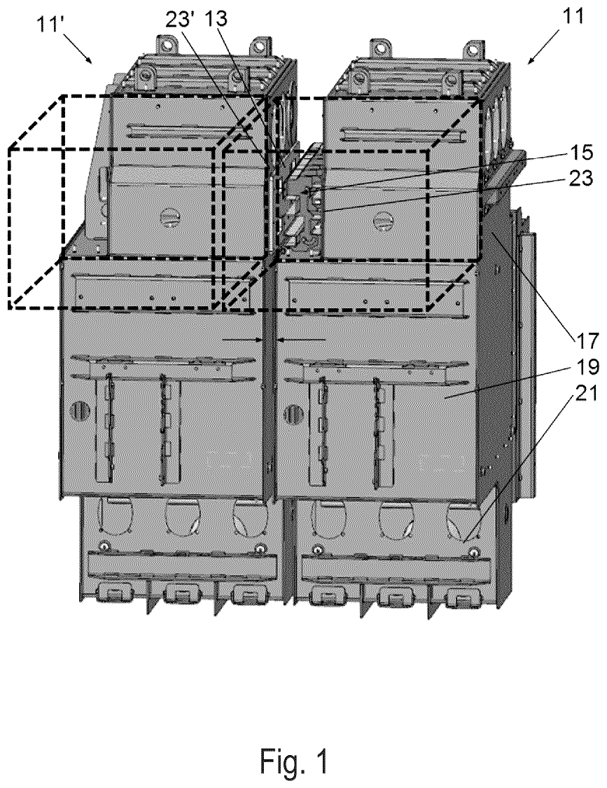

FIG. 1 an arrangement of a pressure vessel according to the invention with an adjacent pressure vessel;

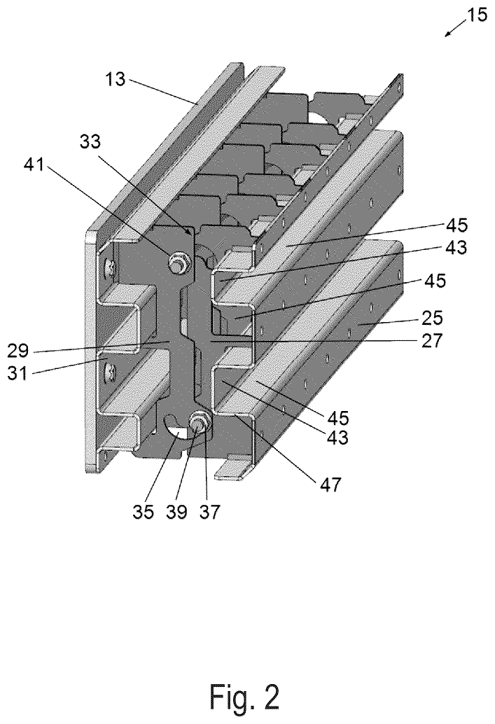

FIG. 2 the stiffening element of FIG. 1 in a detailed view;

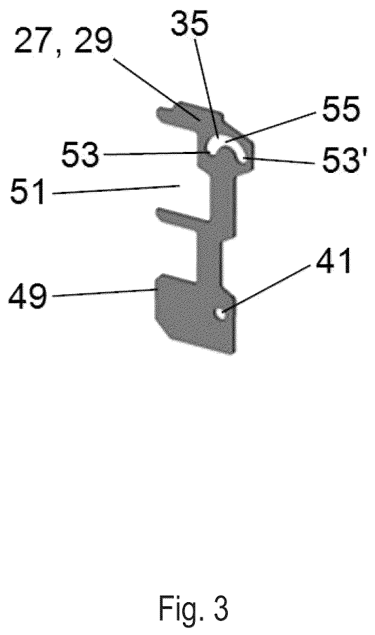

FIG. 3 a detailed view of one of the ribs of the stiffening element of FIG. 2;

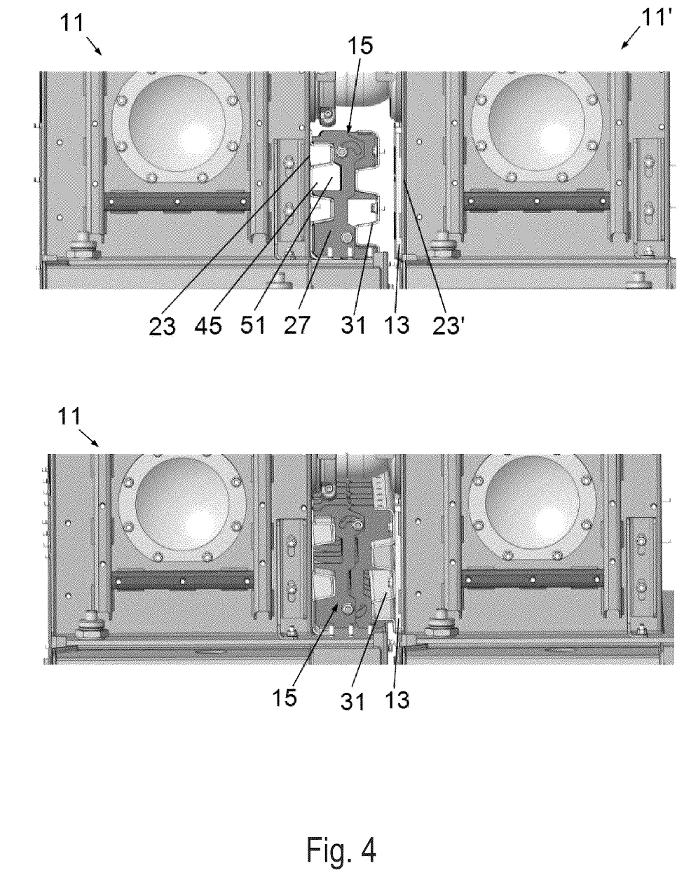

FIG. 4 a detailed view of an arrangement of a pressure vessel according to the invention with an adjacent pressure vessel, wherein the stiffening element is telescoped in or telescoped out;

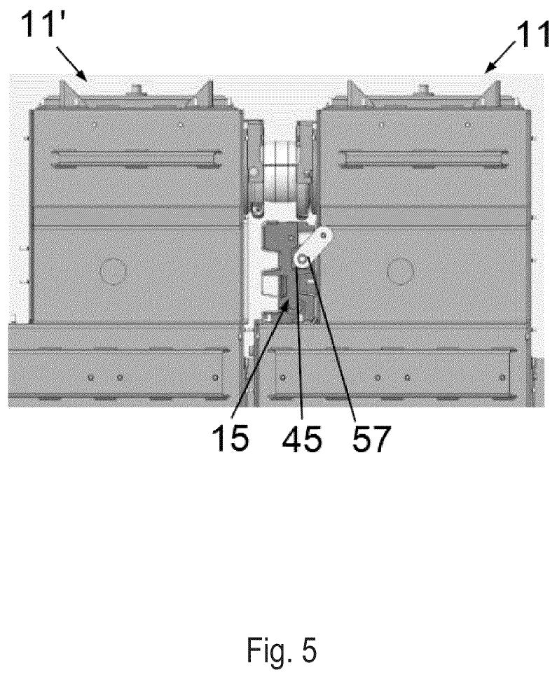

FIG. 5 a detailed view of an arrangement of a pressure vessel according to the invention with an adjacent pressure vessel, wherein a functional component is guided through the stiffening element; and

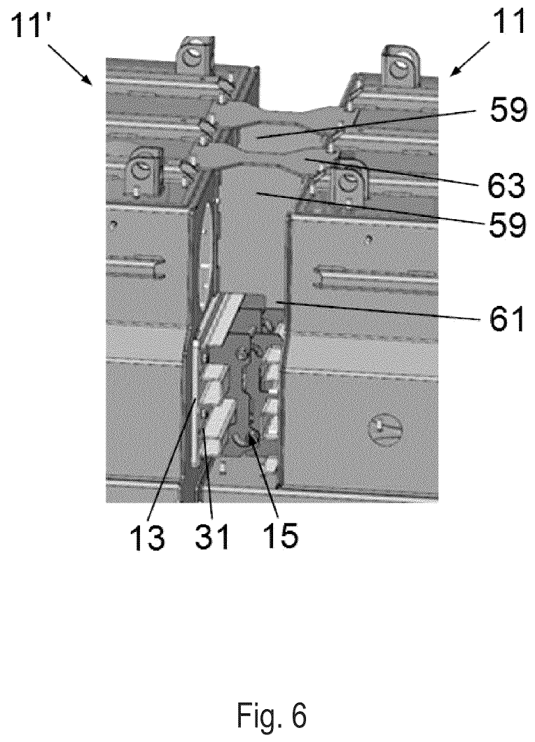

FIG. 6 a detailed view of an arrangement of a pressure vessel according to the invention with an adjacent pressure vessel, wherein blades are inserted between the pressure vessels.

FIG. 1 shows an arrangement of a first pressure vessel 11 according to the invention and a second pressure vessel 11′ arranged adjacent thereto by a spacing D as a possible embodiment of the invention. The pressure vessel 11 comprises a cable connection compartment 21 to connect a switch panel comprising the pressure vessel to an energy network, a busbar compartment 17 to distribute the energy of a connected phase, and a circuit breaker compartment 19 to selectively connect or disconnect a connected phase to or from a busbar. A stiffening element 15 is fastened to an outer side 23 of the pressure vessel 11 and can be telescoped perpendicular to the outer side 23 and locked, wherein, in FIG. 1, the stiffening element 15 is telescoped in. An assembly plate 13, which can have a plurality of recesses for its stiffening, is fastened to the outer side 23′ of the pressure vessel 11′ that is spaced apart in parallel from and disposed opposite to the outer side 23 of the first pressure vessel 11. If the stiffening element 15 is telescoped out, the stiffening element 15 of the first pressure vessel 11 can be fastened to, in particular screwed to, the assembly plate 13 to stiffen the pressure vessel 11 and the second pressure vessel 11′ against one another.

The pressure vessel 11 and the second pressure vessel 11′ are usually provided with a low-voltage cabinet that forms part of a switch panel. The typical outer contour of the respective low-voltage cabinet is illustrated in FIG. 1 by the dashed boxes at the level of the busbar compartment 17.

It can be seen here that the free space corresponding to the spacing D is very small so that a stiffening element, which would be attached instead of the assembly plate 13 and would project further beyond the pressure vessel 11′, would abut the low-voltage cabinet of the pressure vessel 11 when the second pressure vessel 11′ is pulled out (out of the drawing plane) or pushed in (into the drawing plane). On the other hand, an ordinary stiffening element fastened to the pressure vessel 11 instead of the stiffening element 15 could also make it more difficult to pull out or push in the pressure vessel 11 or the pressure vessel 11′ since it could tilt and would therefore have to be laboriously dismantled. However, since the stiffening element 15 can be telescoped and does not project beyond the pressure vessel 11 when it is telescoped in, both the pressure vessel 11 and the pressure vessel 11′ can be pulled out or pushed in without the stiffening element 15 tilting in so doing. Naturally, the stiffening element 15 can also be fastened to other positions of the pressure vessel 11 according to the invention.

The stiffening element 15 of FIG. 1 is represented in a detailed view in FIG. 2. The stiffening element 15 in this respect comprises a fixed profile part 25 with which the stiffening element 15 is welded to the outer side 23 of the pressure vessel 11. Furthermore, the stiffening element 15 of the exemplary embodiment comprises six identical rib pairs 33 spaced apart in parallel from one another. Each rib pair 33 has a fixed rib 27 and a displaceable rib 29 that contacts the fixed rib 27 and is displaceable relative thereto. Each fixed rib 27 is welded to the fixed profile part 25; a displaceable profile part 31 is furthermore welded to each displaceable rib 29. In FIG. 2, the stiffening element 15 is telescoped out and locked and the displaceable profile part 31 is screwed to the assembly plate 13.

Each rib 27, 29 has a slot guide 35 and an opening 41 (not recognizable in FIG. 2). Both the ribs 27, 29 and the slot guides 35 are each formed in a plane perpendicular to the outer side 23, wherein all the ribs 27, 29 are identical components. The fixed profile part 25 and the displaceable profile part 31 can also be two identical components. The ribs 27, 29 of each rib pair 33 are in this respect oriented such that a respective one latch 39 in the form of a rod can be inserted through the slot guide 35 of the one rib 27, 29 of each rib pair 33 and the opening 41 of the other rib 29, 27 of the respective rib pair 33, wherein the two latches 39 can be two identical components. Furthermore, the two latches 39 are each arranged in parallel with the outer side 23 in the respective slot guides 35. Each latch 39 is in this respect received in a form-fitting manner in the respective openings 41 so that the displaceable ribs 29 together with the displaceable profile part 31 can be displaced relative to the fixed ribs 27 along the path predefined by the course of the slot guides 35. In addition, the ends of the respective latch 39 are each provided with a securing device in the form of a nut 37 against an axial displacement of the latch 39.

The fixed profile part 25 comprises a cross-sectional shape 47 having two beads 43 that can have different widths and that serve to stiffen the profile part 25. At the same time, however, the beads 43 also each form a passage 45 through which a functional component 57 (FIG. 5) of the switch panel can be guided through the stiffening element 15. The same applies to the displaceable profile part 31 in the embodiment shown.

In FIG. 3, one of the ribs 27, 29 comprising the slot guide 35 and the opening 41 is shown by way of example in a detailed view. The slot guide 35 comprises a locking section 53 and a locking section 53′, wherein the respective latch 39 of FIG. 2 and the respective locking sections 53, 53′ are releasably latchable to one another. Furthermore, a telescoping section 55 is provided that connects the locking sections 53, 53′ to one another. To release the locking, the displaceable ribs 29 can, for example, be lifted by a fitter so that the respective latch 39 is lifted out of the respective locking sections 53, 53′, whereby the stiffening element 15 can be telescoped.

Alternatively, the slot guide 35 can, for example, have a U-shaped recess that is formed in the respective rib 27, 29, wherein two parallel sections of the slot guide 35 form a first locking section 53 and a second locking section 53′ that are connected to one another via a telescoping section 55. This design of the slot guide allows a particularly reliable stiffening since the wall of the slot guide in the locking sections 53, 53′ is oriented perpendicular to a force introduction of the latch 39.

The rib 27, 29 furthermore has an outer contour 49 that is adapted to the cross-sectional shape 47 of the profile part 25, 31. Furthermore, the rib 27, 29 has a recess 51. All the ribs 27, 29 of the stiffening element 15 are configured in accordance with FIG. 4 and therefore each have the recess 51, whereby a passage 45 (FIG. 2) is also formed between the fixed ribs 27 and the fixed profile part 25.

In the upper representation of FIG. 4, a detailed view of a pressure vessel 11 next to an adjacent pressure vessel 11′ is shown, with the stiffening element 15 being telescoped in and locked. Here, too, in particular a passage 45, which is formed by the recesses 51 of all the fixed ribs 27, a displaceable profile part 31 and an assembly plate 13 are provided, said assembly plate 13 being welded to an outer side 23′ of the pressure vessel 11′ spaced apart in parallel from and disposed opposite the outer side 23 of the pressure vessel 11.

In the lower representation of FIG. 4, the arrangement of the upper representation of FIG. 4 is shown with the stiffening element 15 telescoped out, wherein the stiffening element 15 is locked and the displaceable profile part 31 is screwed to the assembly plate 13.

In FIG. 5, a detailed view of a pressure vessel 11 next to an adjacent pressure vessel 11′ is shown, with the stiffening element 15 being telescoped in and locked. Here, too, in particular a passage 45 is formed through which a functional component 57 of the switch panel is guided through the stiffening element 15.

In FIG. 6, a detailed view of a pressure vessel 11 next to an adjacent pressure vessel 11′ is shown, with the stiffening element 15 being telescoped out and locked. A displaceable profile part 31 of the stiffening element 15 is screwed to an assembly plate 13 of the pressure vessel 11′. Two blades 59 are inserted between the two pressure vessels 11, 11′ and each contact both pressure vessels 11, 11′. The blades 59 can thereby serve as spacers, on the one hand, while an additional stiffening can also be achieved by the blades 59, on the other hand. Furthermore, each blade 59 has an engagement projection 61 that engages into the stiffening element 15, whereby each blade 59 additionally blocks the stiffening element 15. Each blade 59 further has a cross plate 63 via which the blade 59 is screwed to the two pressure vessels 11, 11′.

### REFERENCE NUMERAL LIST

11 pressure vessel
11 second pressure vessel
13 assembly plate
15 stiffening element
17 busbar compartment
19 circuit breaker compartment
21 cable connection compartment
23 outer side
23′ outer side
25 fixed profile part
27 fixed rib
29 displaceable rib
31 displaceable profile part
33 rib pair
35 slot guide
37 nut
39 latch
41 opening
43 bead
45 passage
47 cross-sectional shape
49 outer contour
51 recess
53 locking section
53′ locking section
55 telescoping section
57 functional component
59 blade
61 engagement projection
63 cross plate

1. A gas-tight pressure vessel for a switch panel of electrical energy technology, comprising at least one stiffening element that is fastened to an outer side of the pressure vessel and that is configured as telescopic perpendicular to the outer side and lockable.

2. The gas-tight pressure vessel according to claim 1, wherein the switch panel of electrical energy technology is of medium-voltage technology.

3. The gas-tight pressure vessel according to claim 1,
wherein the stiffening element comprises at least one slot guide and at least one latch that is arranged in the slot guide.

4. The gas-tight pressure vessel according to claim 3,
wherein the slot guide comprises a telescoping section and at least one locking section, with the latch and the locking section being releasably latchable to one another.

5. The gas-tight pressure vessel according to claim 4,
wherein the slot guide has a U-shaped recess, with two parallel sections of the recess forming a first locking section and a second locking section that are connected to one another via the telescoping section.

6. The gas-tight pressure vessel according to claim 3,
wherein the slot guide is formed in a plane perpendicular to the outer side, with the latch being arranged in parallel with the outer side in the slot guide.

7. The gas-tight pressure vessel according to claim 1,
wherein the stiffening element comprises a plurality of rib pairs spaced apart in parallel from one another.

8. The gas-tight pressure vessel according to claim 7,
wherein each rib pair comprises at least one fixed rib, which is oriented perpendicular to the outer side and fastened thereto, and at least one rib that is displaceable relative to the fixed rib.

9. The gas-tight pressure vessel according to claim 8,
wherein the at least one rib that is displaceable relative to the fixed rib contacts the fixed rib.

10. The gas-tight pressure vessel according to claim 1,
wherein at least one rib of the stiffening element has a slot guide in which a latch is arranged.

11. The gas-tight pressure vessel according to claim 1,
wherein at least one rib of the stiffening element has an opening in which a latch is received in a form-fitting and/or force-fitting manner.

12. The gas-tight pressure vessel according to claim 7,
wherein at least one fixed rib of at least one rib pair has a slot guide in which a latch is arranged, with at least one displaceable rib of the rib pair having an opening in which the latch is received in a form-fitting and/or force-fitting manner.

13. The gas-tight pressure vessel according to claim 7,
wherein at least one displaceable rib of at least one rib pair has a slot guide in which a latch is arranged, with at least one fixed rib of the rib pair having an opening in which the latch is received in a form-fitting and/or force-fitting manner.

14. The gas-tight pressure vessel according to claim 7,
wherein the stiffening element comprises a fixed profile part which has at least one bead, which is fastened to the outer side and to which the fixed ribs are fastened, with the outer contours of the fixed ribs being adapted to the cross-sectional shape of the fixed profile part.

15. The gas-tight pressure vessel according to claim 14,
wherein at least one passage is formed between the fixed profile part and the outer side and/or between the fixed profile part and all the fixed ribs, said passage being provided to be able to guide a functional component of the switch panel through the passage of the stiffening element.

16. The gas-tight pressure vessel according to claim 7,
wherein the stiffening element comprises a displaceable profile part that has at least one bead and that is fastened to the displaceable ribs, with the outer contours of the displaceable ribs being adapted to the cross-sectional shape of the displaceable profile part.

17. The gas-tight pressure vessel according to claim 3,
wherein the latch is designed as a rod or bolt that extends in an axial direction, with the ends of the latch each being provided with a securing device, whereby the latch is secured against an axial movement.

18. The gas-tight pressure vessel according to claim 17,
wherein the securing device is a nut and/or a cotter pin.

19. The gas-tight pressure vessel according to claim 1,
wherein the stiffening element comprises at least three component sets having different components, with each of the three component sets including at least two identical components.

20. The gas-tight pressure vessel according to claim 19,
wherein each of the three component sets includes at least two identical components having identical shapes.

21. An arrangement of a first gas-tight pressure vessel comprising at least one stiffening element that is fastened to an outer side of the pressure vessel and that is configured as telescopic perpendicular to the outer side and lockable and a second pressure vessel which is arranged adjacent to the first switch panel by a spacing D and at whose outer side, which is spaced apart in parallel from the outer side of the first pressure vessel and disposed opposite thereto, an assembly plate is fastened at which the stiffening element of the first pressure vessel is mounted.

22. A switch panel of electrical energy technology, comprising a gas-tight pressure vessel that comprises at least one stiffening element that is fastened to an outer side of the pressure vessel and that is configured as telescopic perpendicular to the outer side and lockable.

23. The switch panel according to claim 22 that is of medium-voltage technology.

24. An arrangement of a first switch panel and a second switch panel, the first switch panel, comprising a gas-tight pressure vessel that comprises at least one stiffening element that is fastened to an outer side of the pressure vessel and that is configured as telescopic perpendicular to the outer side and lockable, wherein the second switch panel is arranged adjacent to the first switch panel by a spacing D and the second switch panel has a second pressure vessel at whose outer side, which is spaced apart in parallel from the outer side of the pressure vessel of the first switch panel and disposed opposite thereto, an assembly plate is fastened at which the stiffening element of the first pressure vessel is mounted.

25. A method for stiffening a gas-tight pressure vessel according to claim 1 that is arranged in a switch panel, wherein the switch panel is arranged spaced apart in parallel from an adjacent second switch panel having a second pressure vessel, comprising the following steps:
transferring the stiffening element to the telescoped-out state, locking the stiffening element, and
fastening the stiffening element to the second pressure vessel.
